(19) United States
(12) Patent Application Publication
(10) Pub. No.: US 2009/0085268 A1
(43) Pub. Date: Apr. 2, 2009

(54) Handicraft work assisting device

(75) Inventor: Katsuhiko Ozeki, Osaka-shi (JP)

Correspondence Address: HAMRE, SCHUMANN, MUELLER & LARSON, P.C., P.O. BOX 2902, MINNEAPOLIS, MN, 55402-0902, US

(73) Assignee: CLOVER MFG CO., LTD., Osaka-shi (JP)

(21) Appl. No.: 12/221,589

(22) Filed: Aug. 5, 2008

(30) Foreign Application Priority Data
Aug. 8, 2007 (JP) 2007-206454

(51) Int. Cl. B23Q 1/25

(52) U.S. Cl. 269/48

(57) ABSTRACT

A handicraft work assisting device includes an elongated main body and a push bar. The main body includes a tubular portion formed with a through-hole extending in the longitudinal direction of the tubular portion. The push bar is insertable into the through-hole. The main body further includes a flange that is provided at an end of the tubular portion. The flange is provided with a groove portion extending in a direction perpendicular to the longitudinal direction.

### BACKGROUND OF THE INVENTION

1. Field of the Invention

The present invention relates to an assisting device for facilitating handicraft work such as patchwork.

2. Description of the Related Art

In the field of handicraft works such as patchwork, a technique so called “puff quilt” is known as one of the methods that provide excellent ornamental effects. For example, U.S. Pat. No. 5,899,160 discloses a conventional puff quilt square maker and a method for fabricating a puff quilt square. The puff quilt is generally performed with a plurality of square-shaped quilting materials (puff). The puff is made through superposing a pleated cloth over a base cloth and sewing these cloths together, which allows forming various design patterns depending on the pleating form, and also stuffing padding in between the cloths, to thereby form a three-dimensionally swollen shape. To practically form the puff, for example, two pieces of square cloths that are different in size are prepared. Each of the four sides of the larger cloth is pleated so as to make the size thereof the same with the smaller cloth, and the pleats are temporarily fixed with marking pins. Then the two cloths are laid on each other and a sewing margin is defined so as to sew the perimeter of the stacked cloths. In the case where the puff is to be stuffed with padding, for example a portion of the perimeter is left open for inserting the padding therethrough, instead of sewing the entire perimeter, and then the cloths are turned inside out through the opening, after which the padding is stuffed and the opening is sewn to close. The puff thus made up obtains a shape swelling toward the upper side, as shown in FIG. 11. The puff quilt is made up by combining a plurality of such puffs and sewing the edges together, or sewing the puffs onto another base cloth.

When performing the patchwork with the puff quilt, a large number of puffs are often employed according to the design. In the case where the puffs are to be stuffed with padding, the padding is to be inserted through the opening, however the opening is prone to be so small that it becomes difficult to insert the padding, because the pleats on the four sides are sewn together. Besides, there are such cases that the two cloths are once sewn with the face sides oriented inside, and turned inside out through the opening. The job of thus reversing the cloths is troublesome, although such method offers the advantage that the sewing margin becomes unseen. Thus, when the making process of the puff includes stuffing the puff with padding or reversing the cloths, the job is troublesome to the worker. Moreover, in the case where a multitude of puffs are to be made, the burden imposed on the worker becomes considerable.

### SUMMARY OF THE INVENTION

The present invention has been proposed in view of the foregoing situation. It is therefore an object of the present invention to provide a handicraft work assisting device that permits, when making a quilt material such as a puff, efficiently stuffing the puff with padding and reversing the cloths sewn together.

According to the present invention, there is provided a handicraft work assisting device that comprises: a main body including a tubular portion formed with a through-hole extending in a longitudinal direction of the tubular portion; and a push bar that is insertable into the through-hole. The main body further includes a flange provided at an end of the tubular portion. This flange is provided with a groove portion extending in a direction perpendicular to the longitudinal direction of the tubular portion.

Preferably, the tubular portion may have a circular cross section.

Preferably, the groove portion may have a curved inner surface defining the shape of the groove.

Preferably, the flange may include flat plate portions flanking the groove portion and extending outward, that is, away from the groove portion.

Preferably, the tubular portion may include a tip end that is oblique to the longitudinal direction of the tubular portion.

Preferably, the main body may be transparent.

Preferably, the push bar may be of a plate shape having a width narrower than the inner diameter of the through-hole. One end of the push bar may be formed with a recess, so that the end is provided with two mutually-spaced protrusions or horns each extending outward in the longitudinal direction of the tubular portion.

Preferably, the other end of the push bar may be chamfered so as to have rounded corners.

Other features and advantages of the present invention will become more apparent through the following detailed description given with reference to the accompanying drawings.

### BRIEF DESCRIPTION OF THE DRAWINGS

FIG. 1 is a perspective view showing a handicraft work assisting device according to the present invention;

FIG. 2 is a front view showing a main body of the device;

FIG. 3 is a cross-sectional view taken along a line III-III in FIG. 2;

FIG. 4 is a front view of the main body for explaining a process of use of the handicraft work assisting device shown in FIG. 1;

FIG. 5 is a front view of the main body and a push bar for explaining a process of use of the handicraft work assisting device shown in FIG. 1;

FIG. 6 is a side view of the push bar for explaining a process of use of the handicraft work assisting device shown in FIG. 1;

FIG. 7 is a fragmentary perspective view of the push bar for explaining a process of use of the handicraft work assisting device shown in FIG. 1;

FIG. 8 is a fragmentary front view of the main body for explaining a process of use of the handicraft work assisting device shown in FIG. 1;

FIG. 9 is a fragmentary front view of the main body and the push bar for explaining a process of use of the handicraft work assisting device shown in FIG. 1;

FIG. 10 is a fragmentary front view of the main body and the push bar for explaining a process of use of the handicraft work assisting device shown in FIG. 1; and

FIG. 11 is a perspective view showing an example of the quilt material made up with the handicraft work assisting device shown in FIG. 1.

### DETAILED DESCRIPTION OF THE PREFERRED EMBODIMENTS

Preferred embodiments of the present invention will be described below with reference to the accompanying drawings.

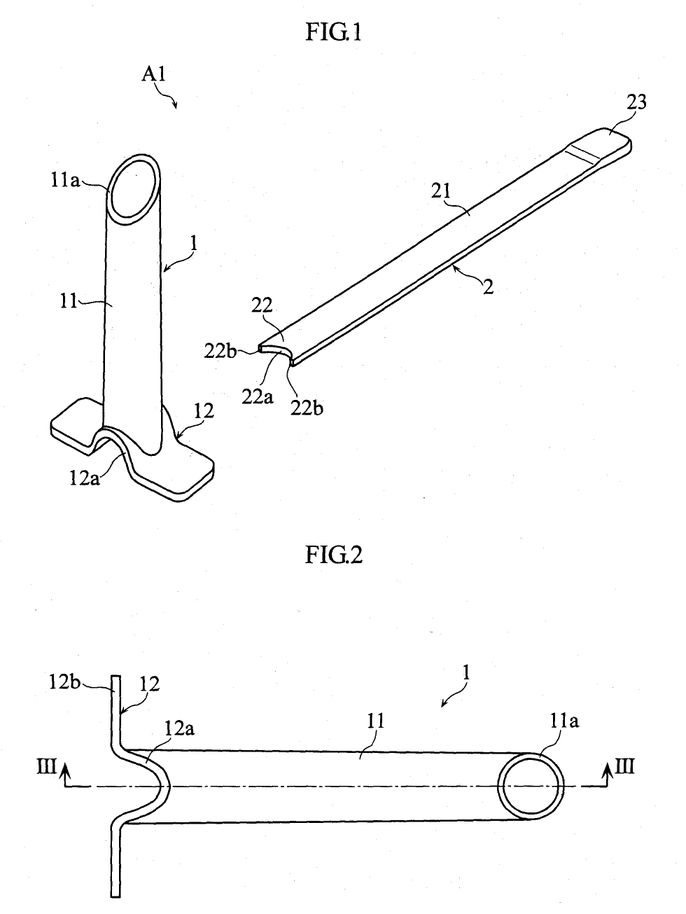

FIG. 1 is a perspective view showing a handicraft work assisting device according to the present invention. The illustrated handicraft work assisting device A1 includes a main body 1 and a push bar 2. The assisting device A1 is intended to facilitate, when making a quilt material such as a puff, stuffing the puff with padding or reversing the cloths sewn together.

The main body 1 includes a tubular portion 11, and an outer flange 12 provided so as to outwardly extend from an end portion of the tubular portion 11. The main body 1 (hence the tubular portion 11 and the flange 12) is made of a resin (such as polypropylene) which is transparent and has an appropriate mechanical strength. The tubular portion 11 is formed with a through-hole extending longitudinally of the tubular portion, and therefore has a circular cross section. The through-hole has a predetermined inner diameter. The other end 11a of the tubular portion 11 is an obliquely cut portion that presents a pointed profile.

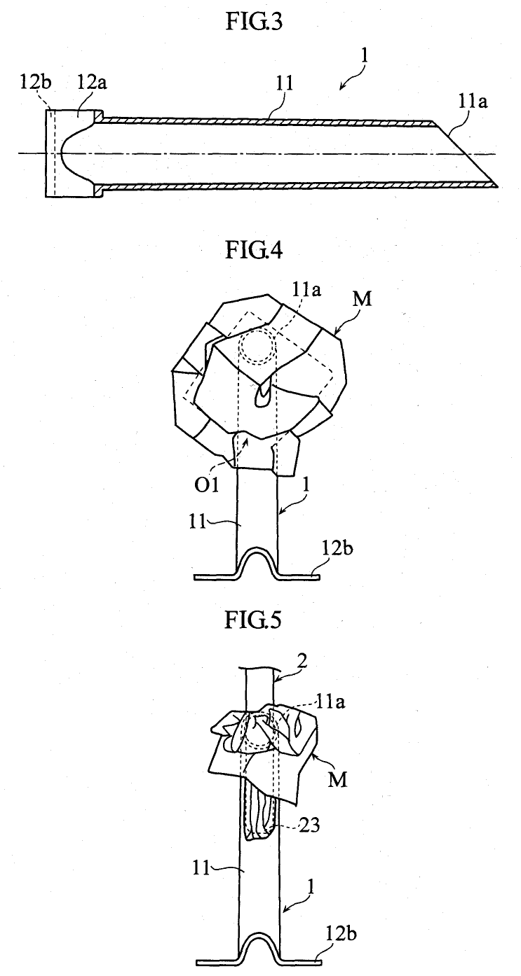

The flange 12 includes, as seen from FIGS. 2 and 3, a groove portion 12a formed so as to extend in a direction perpendicular to the axis of the tubular portion 11, and a flat plate portion 12b extending from the groove portion 12a. The groove portion 12a has a curved concave cross-section whose width increases as proceeding away from the tubular portion 11 along the axis of the tubular portion 11. The maximum width of the groove portion 12a is equal to or larger than the inner diameter of the tubular portion 11 (that is, the diameter of the through-hole). The flat plate portions 12b, flanking the groove portion 12a, are provided so as to outwardly extend within the same plane.

The push bar 2 is of a plate shape having a generally constant width as a whole, and formed of a synthetic resin such as ABS (acrylonitrile butadiene styrene) resin, having a predetermined strength. The push bar 2 has a width narrower than the inner diameter of the tubular portion 11 of the main body 1, so as to be insertable into the tubular portion 11. The main plate portion 21 between the end portions of the push bar 2 is intended to be held by the user for manipulation, and has a generally uniform rectangular cross-section. One of the end portions 22 of the push bar 2 includes a recessed portion 22a formed such that the respective widthwise end protrusions or horns 22b protrude beyond the widthwise central portion the end. The other end portion 23 of the push bar 2 is chamfered so as to have rounded corners.

Referring now to FIGS. 4 through 10, description will be given to a method of making a puff with the use of the assisting device A1 of the present invention.

First, cloths that are sewn together (referred to as motif M below) are prepared. The motif M includes a pleated cloth (top cloth) and another cloth (base cloth) laid on each other with the face side oriented inside, and with the four sides sewn together. It is to be noted, however, that the entire perimeter is not sewn but a part of one of the sides is left unsewn, to thereby provide an opening O1. Also, a surplus portion of the sewing margin is to be cut off.

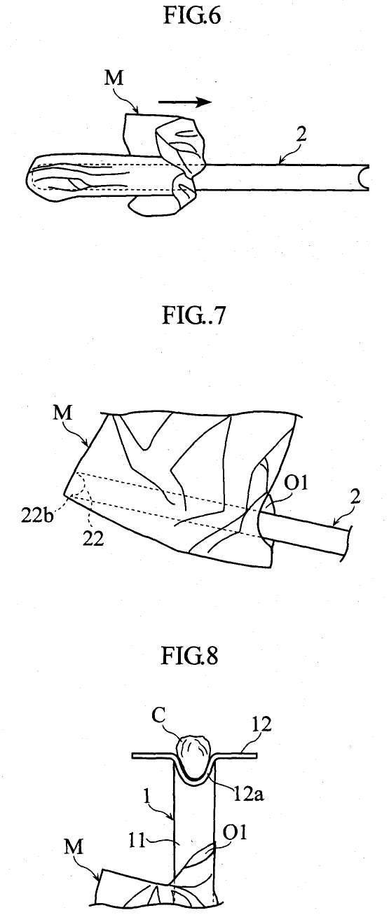

The motif M is then reversed. In this embodiment, the end portion 11a of the tubular portion 11 of the main body 1 is inserted into the opening O1 of the motif M as shown in FIG. 4. Then the end portion 23 of the push bar 2 is inserted into the opening of the end portion 11a of the main body 1, from over the cloths, as shown in FIG. 5. The main body 1 is then removed, and the entirety of the motif M is reversed as shown in FIG. 6. After the push bar 2 is pulled out of the motif M, the end portion 22 of the push bar 2 is inserted through the opening O1 as shown in FIG. 7, to thereby rectify the shape of the corners utilizing the horns 22b.

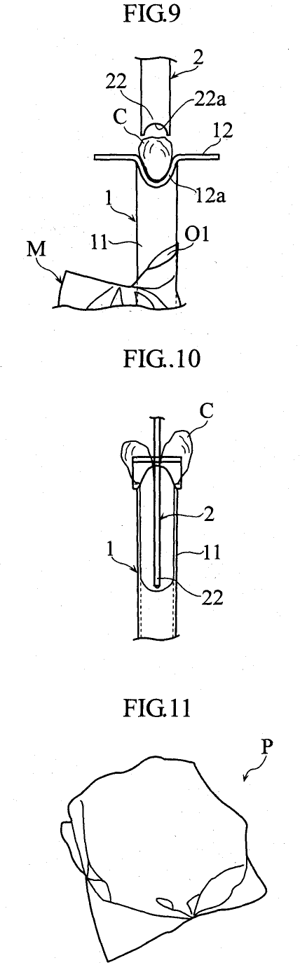

The above is followed by stuffing the motif M with the padding. In this embodiment, as shown in FIG. 8, the tubular portion 11 (end portion 11a) of the main body 1 is inserted through the opening O1 of the motif M, and an appropriate amount of padding C is placed in the groove portion 12a of the outer flange 12. The end portion 22 of the push bar 2 is then brought to such a position that the recessed portion 22a is confronted with the groove portion 12a of the main body 1, as shown in FIG. 9. Now the push bar 2 is pressed down into the main body 1 toward the end portion 11a, to thereby insert the padding C into inside the motif M. FIG. 10 is a partially cut away side view showing the state where the padding C is being inserted. Repeating such action leads to stuffing the motif M with a desired amount of padding C.

Finally the opening O1 is sewn to close. Through the foregoing process, the puff P stuffed with the padding C as shown in FIG. 11 can be obtained.

As is apparent from the foregoing description, the assisting device A1 according to this embodiment facilitates efficiently reversing the motif M and stuffing the puff P with the padding C, when making up the puff P. More particularly, although the size of the opening O1 of the motif M is prone to become too small because the pleated portion along the four sides has to be sewn, simply inserting the end portion 11a of the main body 1 through the opening O1 enables smoothly reversing the motif M and filling the puff P with the padding C, utilizing the push bar 2.

Since the main body 1 is made of a transparent resin, the status inside the tubular portion 11 can be visually recognized from outside, which permits easily observing whether the reversing operation or the stuffing operation is being properly carried out. The end portion 11a of the main body 1 includes an obliquely cut portion so as to present a sharp profile, which makes it easier to insert the end portion 11a through the opening O1, thereby making the device more comfortable to use. The flat plate portions 12b of the outer flange 12 of the main body 1, extending from the respective lateral portions of the groove portion 12a, enables the main body 1 to be placed in an erected form. Also, the flat plate portions 12b provided on both sides are comfortable in holding with the fingers, which is another advantage that makes the device more comfortable to use.

Utilizing the chamfered end portion 23 of the push bar 2 when reversing the motif M allows preventing such drawbacks that the cloth or the stitch is torn, thereby making the device more comfortable to use. Also, as shown in FIG. 7, utilizing the end portion 22 of the push bar 2 enables rectifying the shape of the corners of the motif M after reversing the same, which constitutes another useful feature of the device.

When inserting the padding C into inside the motif M, the padding C can be held between the flange 12 and the recessed portion 22a of the push bar 2. Specifically, as stated referring to FIG. 9, the padding C can be securely retained between the groove portion 12a of the flange 12 and the recessed portion 22a of the push bar 2. Then, as being pushed by the push bar 2, the padding C is led into the tubular portion 11, guided by the groove portion 12a of the outer flange 12. Since the groove portion 12a has a curved concave shape, the padding C can be smoothly introduced into the tubular portion 11 without being caught by the groove portion 12a. Also, upon pressing down the push bar 2, the padding C is concentrated to the central portion of the recessed portion 22a, so as to make the fiber of the padding C densely concentrated. This prevents the push bar 2 from penetrating through the padding C, while also preventing the padding C from getting seized between the tubular portion 11 and the push bar 2. Further, since the push bar 2 is of a plate shape, a sufficient space for the padding C to pass through can be secured between the inner wall of the tubular portion 11 and the push bar 2, as shown in FIG. 10. Such configuration enables, therefore, smooth inserting of an adequate amount of padding C into the motif M by a single insertion action of the push bar 2.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A handicraft work assisting device, comprising:
a main body including a tubular portion formed with a through-hole extending in a longitudinal direction of the tubular portion; and
a push bar insertable into the through-hole;
wherein the main body further includes a flange provided at an end of the tubular portion, the flange being provided with a groove portion extending in a direction perpendicular to the longitudinal direction.

2. The handicraft work assisting device according to claim 1, wherein the tubular portion has a circular cross section.

3. The handicraft work assisting device according to claim 2, wherein the groove portion has a curved inner surface.

4. The handicraft work assisting device according to claim 3, wherein the flange includes flat plate portions flanking the groove portion and extending outward.

5. The handicraft work assisting device according claim 1, wherein the tubular portion includes a tip end oblique to the longitudinal direction.

6. The handicraft work assisting device according claim 1, wherein the main body is transparent.

7. The handicraft work assisting device according claim 1, wherein the push bar is of a plate shape having a width narrower than an inner diameter of the through-hole, the push bar having a first end formed with a recess.

8. The handicraft work assisting device according to claim 7, wherein the push bar has a second end that is chamfered.
